(19) United States
(12) Patent Application Publication
(10) Pub. No.: US 2025/0059993 A1
(43) Pub. Date: Feb. 20, 2025

(54) LOCATING STRUCTURE

(71) Applicant: FIVETECH TECHNOLOGY INC., New Taipei City (TW)

(72) Inventors: TING-JUI WANG, New Taipei City (TW); WEI-CHEN HUANG, New Taipei City (TW); MIN-CHANG HSIEH, New Taipei City (TW)

(73) Assignee: FIVETECH TECHNOLOGY INC., New Taipei City (TW)

(21) Appl. No.: 18/937,069

(22) Filed: Nov. 5, 2024

Related U.S. Application Data
(63) Continuation of application No. 16/923,122, filed on Jul. 8, 2020.

(30) Foreign Application Priority Data
Jul. 11, 2019 (TW) 108209054

(51) Int. Cl. F16B 5/02

(52) U.S. Cl. CPC F16B 5/0216

(57) ABSTRACT

A locating structure includes a fixture and a locating member. The fixture includes a body and a fastener, wherein the fastener is movably provided at the body. The body is configured to assemble with a first object, and the fastener is configured to fasteningly connect to a second object or be removed from the second object. The locating member is movably assembled with the body, and the locating member may press against or drive the fastener to locate the fastener at a located position, or the locating member may move or drive the fastener to locate the fastener at a locating-released position. Thus, the locating member may be moved to locate the fastener at the located position or at the locating-released position, so as to complete coupling or separation of at least two objects, achieving the effect of repeated quick coupling and separation.

### CROSS-REFERENCE TO RELATED APPLICATION

This application is a continuation application of U.S. application Ser. No. 16/923,122 filed on Jul. 8, 2020, the entire contents of which are hereby incorporated by reference for which priority is claimed under 35 U.S.C. § 120.

### BACKGROUND OF THE INVENTION

### 1. Field of the Invention

The present invention relates to a locating structure, and in particular to a locating structure capable of completing coupling and separation of at least two objects, thus achieving repeated quick coupling and separation.

### 2. Description of the Related Art

In general, to couple at least two objects (or three objects), lock connection is usually performed using a screw so as to couple the objects.

However, although being capable of coupling at least two objects in a manner of not being separated easily, the conventional fixing means above may result in a complicated assembly process, and even a complicated disassembly process of at least one of the objects due to the fixed connection of the screw.

Therefore, the present invention aims to disclose a locating structure capable of completing coupling and separation of at least two objects and thus achieving the objective of repeated quick coupling and separation.

### BRIEF SUMMARY OF THE INVENTION

An objective of the present disclosure is to provide a locating structure, in particular a locating structure capable of completing coupling and separation of at least two objects and thus achieving the objective of repeated quick coupling and separation.

To achieve at least the above objective, the present disclosure provides a locating structure including a fixture and a locating member. The fixture includes a body and a fastener, wherein the fastener is movably provided at the body. The body is configured to assemble with a first object, and the fastener is configured to fasteningly connect to a second object or be removed from the second object. The locating member is movably assembled with the body, and the locating member may press against or drive the fastener to locate the fastener at a located position, or the locating member may move away or drive the fastener to locate the fastener at a locating-released position.

The present disclosure further provides a locating structure including a fixture and a fastening member. The fixture includes a body and a fastener, wherein the fastener is movably provided at the body. The body is configured to assemble with a first object, and the fastener is configured to fasteningly connect to a second object, or be removed from the second object. The locating member may press against or drive the fastener to locate the fastener at a located position, or the locating member may move away or drive the fastener to locate the fastener at a locating-released position.

In an embodiment, in the foregoing locating structure, the body includes a joining portion, and the joining portion is assembled with the first object.

In an embodiment, in the foregoing locating structure, the fastener includes a head portion at one end thereof and a fastening connecting portion at the other end thereof. The fastening connecting portion is configured to fasteningly connect to the second object. The locating member is configured to press against, move away, push, rotate or drive the head portion, so as to locate the fastening connecting portion at the located position or at the locating-released position.

In one embodiment, the foregoing locating structure further includes an elastic element. One end of the elastic element presses against the body and the other end presses against the fastening connecting portion.

In one embodiment, the foregoing locating structure further includes an elastic element. One end of the elastic element presses against the body and the other end presses against the head portion.

In one embodiment, the foregoing locating structure further includes an elastic element. One end of the elastic element presses against the body and the other end presses against the fastener.

In one embodiment, in the foregoing locating structure, the head portion includes a guiding surface pressing against the locating member on an outer periphery thereof.

In one embodiment, in the foregoing locating structure, the locating member includes a sliding seat or a pressing portion, and the pressing portion is provided at one end of the sliding seat.

In one embodiment, in the foregoing locating structure, the locating member includes a limiting portion. The sliding seat may be moved to press the pressing portion against the fastener and to form limitation by the limiting portion and an outer side of the body so as to locate the fastener at the located position, or the pressing portion may move away the fastener to disengage the limiting portion from the body so as to locate the fastener at the locating-released position.

In one embodiment, in the foregoing locating structure, the pressing portion includes a fitting connecting portion, and the fitting connecting portion may be fitted into one end of the fastener.

In one embodiment, in the foregoing locating structure, the pressing portion includes a connected guiding portion, and the connected guiding portion is configured to press against an outer periphery of the head portion.

In one embodiment, in the foregoing locating structure, the locating member includes a sliding seat and a pressing portion or at least one limiting portion. The pressing portion is provided at one end of the sliding seat, the limiting portion is provided on an inner side of the sliding seat, and the body is movably provided in the sliding seat.

In one embodiment, in the foregoing locating structure, the sliding seat may be moved to press the pressing portion against the fastener so as to locate the fastener at a locked position, or the pressing portion may move away the fastener to disengage the limiting portion from the body so as to locate the fastener at an unlocked position.

In one embodiment, in the foregoing locating structure, the sliding seat may be moved to press the pressing portion against the fastener, so as to rotate the fastener.

In one embodiment, in the foregoing locating structure, the guiding surface is an inclined surface, an arc surface, a curved surface, a stepped surface, a planar surface, a protrusion, a recess, a notch, a groove, an opening, a slot or a hole.

In one embodiment, in the foregoing locating structure, the connected guiding portion is an inclined surface, an arc surface, a curved surface, a stepped surface, a planar surface, a protrusion, a recess, a notch, a groove, an opening, a slot or a hole.

In one embodiment, in the foregoing locating structure, the fastening connecting portion is a column, a fastener, an outer fastener, an inner fastener or a thread body.

In one embodiment, in the foregoing locating structure, the fastener includes a head portion at one end thereof and a fastening connecting portion at the other end thereof. The locating member is configured to press against, move away, push, rotate or drive the head portion.

In one embodiment, in the foregoing locating structure, the locating member includes a pressing portion, and the head portion includes a corresponding pressing portion corresponding in position to the pressing portion.

In one embodiment, in the foregoing locating structure, the pressing portion or the corresponding pressing portion is an inclined surface, an arc surface, a curved surface, a stepped surface, a planar surface, a protrusion, a recess, a notch, a groove, an opening, a slot or a hole.

In one embodiment, in the foregoing locating structure, the fixture and the locating member include a connected connecting portion. The connecting portion is configured to drive the fastener so as to locate the fastener at the located position or at the locating-released position.

In one embodiment, in the foregoing locating structure, the head portion and the locating member include a connected connecting portion. The connecting portion is configured to drive the fastening connecting portion so as to locate the fastening connecting portion at the located position or at the locating-released position.

In one embodiment, in the foregoing locating structure, the head portion and the pressing portion have a connected connecting portion. The connecting portion is configured to drive the fastening connecting portion so as to locate the fastening connecting portion at the located position or at the locating-released position.

In one embodiment, in the foregoing locating structure, the pressing portion includes a connected guiding portion or fitting connecting portion. The connected guiding portion may press against the outer periphery of the head portion and be fitted into one end of the fastener by the fitting connecting portion.

The present disclosure further provides a locating structure including a fixture and a driving member. The fixture includes a body and a fastener. The fastener is movably provided at the body. The body is configured to assemble with a first object. The fastener is configured to fasteningly connect to a second object or be removed from the second object. The driving member and the body are movably assembled, and the driving member may drive the fastener to locate the fastener at a locked position, or the driving member may drive the fastener to locate the fastener at an unlocked position.

In one embodiment, in the foregoing locating structure, the body includes a joining portion, and the joining portion is configured to assemble with the first object.

In one embodiment, in the foregoing locating structure, a guiding portion is provided on each of two sides of the outer periphery of the body, and the guiding portions may perform guiding on an inner side of the driving member.

In one embodiment, in the foregoing locating structure, the body includes a blocking portion on the outer periphery of a top end thereof, and the blocking portion may perform blocking and limiting on an inner side of the driving member.

In one embodiment, in the foregoing locating structure, the fastener includes a head portion at one end and a fastening connecting portion at the other end. The fastening connecting portion is configured to fasteningly connect to the second object. The driving member may drive the head portion to locate the fastening connecting portion at the locked position or at the unlocked position.

In one embodiment, in the foregoing locating structure, the head portion includes a butting connecting portion on an end surface thereof, and the butting connecting portion is connected to the driving member.

In one embodiment, in the foregoing locating structure, the head portion and the fastening connecting portion are assembled by an assembly portion.

In one embodiment, in the foregoing locating structure, the driving member includes a sliding seat, an impelling portion, at least one sliding portion and at least one locating portion. The impelling portion is provided at one end of the sliding seat, the sliding portion is provided on an inner side of the sliding seat, and the locating portion is provided on an inner side of the sliding seat.

In one embodiment, in the foregoing locating structure, the body is movably provided in the sliding seat, the impelling portion is connected to an end surface of the fastener to further move the sliding seat to guide the sliding portion on the outer periphery of the body, so as to enable the impelling portion to drive the fastener and form limitation by the locating portion and the outer side of the body to further locate the fastener at the locked position, or to enable the impelling portion to move away the fastener to disengage the locating portion from the body to further locate the fastener at the unlocked position.

In one embodiment, in the foregoing locating structure, the impelling portion includes a fitting connecting portion on a bottom surface thereof, and the fitting connecting portion may be fitted into an end surface of the fastener.

Accordingly, in the locating structure of the present invention, the locating member may be moved to locate the fastener at the located position or at the locating-released position, so as to complete coupling and separation of at least two objects, hence achieving the objective of repeated quick coupling and separation.

### BRIEF DESCRIPTION OF THE DRAWINGS

FIG. 1 is an appearance schematic diagram according to a first embodiment of the present invention.

FIG. 2 is an exploded schematic diagram according to the first embodiment of the present invention.

FIG. 3 is a schematic diagram of a cross-section state according to the first embodiment of the present invention.

FIG. 4 is a first schematic diagram of a state of use according to the first embodiment of the present invention.

FIG. 5 is a second schematic diagram of a state of use according to the first embodiment of the present invention.

FIG. 6 is an appearance schematic diagram according to a second embodiment of the present invention.

FIG. 7 is a first schematic diagram of a state of use according to the second embodiment of the present invention.

FIG. 8 is a second schematic diagram of a state of use according to the second embodiment of the present invention.

FIG. 9 is a schematic diagram of different structural forms of a fastening connecting portion of the present invention.

FIG. 10 is a first schematic diagram of a state of use according to a third embodiment of the present invention.

FIG. 11 is a second schematic diagram of a state of use according to the third embodiment of the present invention.

FIG. 12 is a schematic diagram of a state of use according to a fourth embodiment of the present invention.

FIG. 13 is a schematic diagram of a state of use according to a fifth embodiment of the present invention.

FIG. 14 is an appearance schematic diagram according to a sixth embodiment of the present invention.

FIG. 15 is an exploded schematic diagram according to the sixth embodiment of the present invention.

FIG. 16 is a schematic diagram of a cross-section state according to the sixth embodiment of the present invention.

FIG. 17 is a first schematic diagram of a state of use according to the sixth embodiment of the present invention.

FIG. 18 is a second schematic diagram of a state of use according to the sixth embodiment of the present invention.

### DETAILED DESCRIPTION OF THE INVENTION

To facilitate understanding of the object, characteristics and effects of this present disclosure, embodiments together with the attached drawings for the detailed description of the present disclosure are provided.

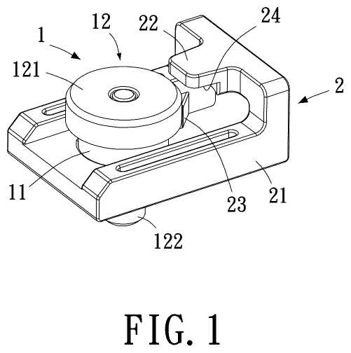

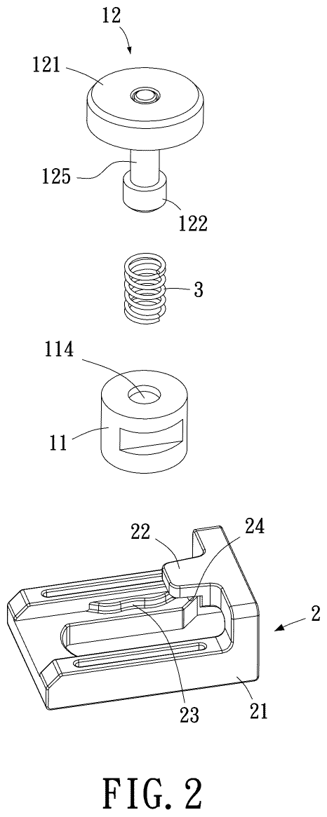

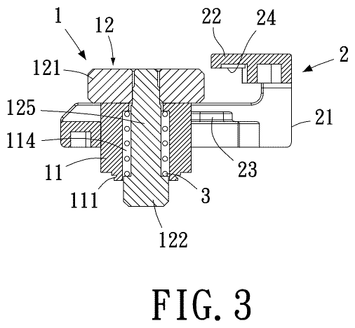

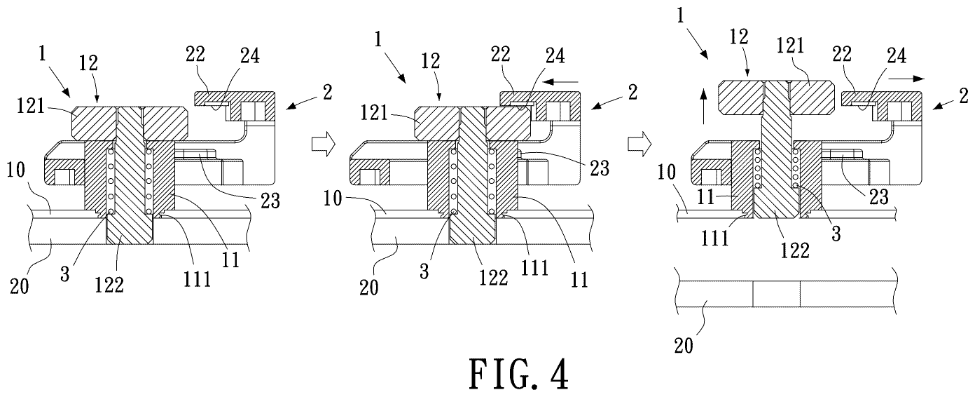

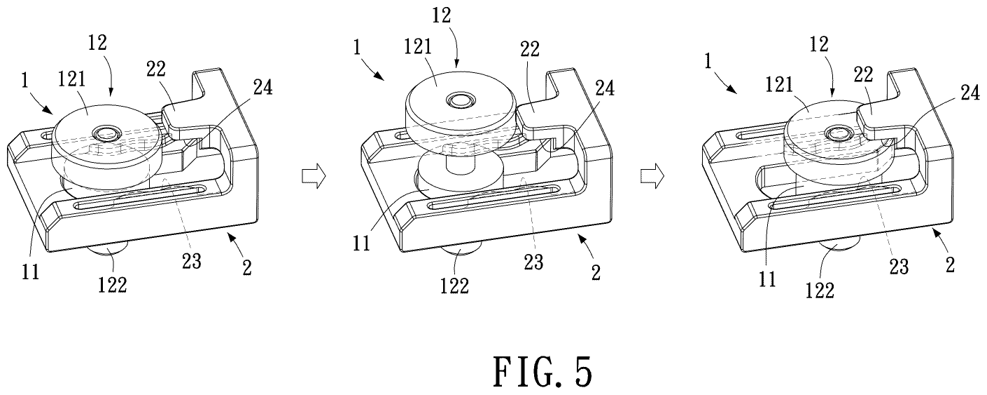

Referring to FIG. 1 to FIG. 5, as shown in the drawings, the present invention provides a locating structure which includes a fixture 1 and a locating member 2.

The fixture 1 includes a body 11 and a fastener 12, wherein the fastener 12 is movably provided at the body 11. The body 11 is configured to assemble with a first object 10, and the fastener 12 is configured to fasteningly connect to a second object 20 or be removed from the second object 20.

The locating member 2 is movably assembled with the body 11. The locating member 2 may press against the fastener 12 to locate the fastener 12 at a located position, or the locating member 2 may move away the fastener 12 to locate the fastener 12 at a locating-released position.

When the present invention is in use, the fastener 12 may be fasteningly connected to the second object 20, and the locating member 12 is then moved in a direction toward the fastener 12 to press the bottom of the locating member 2 against one end of the fastener 12, thereby locating the fastener 12 at the located position and fasteningly connecting the fastener 12 to the second object 20 in a stable manner, so as to stably couple the first object 10 with the second object 20. To separate the first object 10 from the second object 20, the locating member 2 is moved in a direction away from the fastener 12 to have the bottom of the locating member 2 depart from one end of the fastener 12, thereby locating the fastener 12 at the locating-released position and removing the fastener 12 from the second object 20, so as to separate the first object 10 from the second object 20. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, the body 11 includes a joining portion 111. The joining portion 111 is assembled with the first object 10. Thus, the body 11 may be stably coupled with the first object 10 using the joining portion 111, so as to facilitate subsequent operations of the fastener 12 and the locating member 2.

In a preferred embodiment of the present invention, the fastener 12 includes a head portion 121 at one end thereof and a fastening connecting portion 122 at the other end thereof. The fastening connecting portion 122 is configured to fasteningly connect to the second object 20. The locating member 2 is configured to press against, move away (push, rotate or drive) the head portion 121, so as to locate the fastening connecting portion 122 at the located position or at the locating-released position. Thus, the fastening connecting portion 122 of the fastener 12 may be fasteningly connected to the second object 20. Then, the locating member 2 is moved in a direction toward the fastener 12 to press the bottom of the locating member 2 against the head portion 121 at one end of the fastener 12, thereby locating the fastening connecting portion 122 at the located position and fasteningly connecting the fastening connecting portion 122 to the second object 20 in a stable manner, so as to stably couple the first object 10 with the second object 20. To separate the first object 10 from the second object 20, the locating member 2 is moved in a direction away from the fastener 12 to have the bottom of the locating member 2 depart from the head portion 121, thereby locating the fastening connecting portion 122 at the locating-released position and removing the fastening connecting portion 122 from the second object 20, so as to separate the first object 10 from the second object 20. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, an elastic element 3 is further included. The elastic element 3 has one end thereof pressing against the body 11, and the other end thereof pressing against the fastening connecting portion 122 (or the fastener 12). As a result of being pressed by the elastic element 3, the fastening connecting portion 122 is thus enabled to normally extend out of the body 11. To put to use, the head portion 121 may be pulled to first withdraw the fastening connecting portion 122 into the body 11, and the elastic element 3 at this point in time is in a compressed state. Once having corresponded to the second object 20, the head portion 121 is then released to release the elastic element 3 such that the fastening connecting portion 122 is fasteningly connected to the second object 20 automatically. Moreover, the locating member 2 is moved in a direction toward the fastener 12 to press the bottom of the locating member 2 against the head portion 121, thereby locating the fastening connecting portion 122 at the located position and fasteningly connecting the fastening connecting portion 122 to the second object 20 in a stable manner, so as to stably couple the first object 10 with the second object 20. To separate the first object 10 from the second object 20, the locating member 2 is moved in a direction away from the fastener 12 to have the bottom of the locating member 2 depart from the head portion 121, thereby locating the fastening connecting portion 122 at the locating-released position. The head portion 121 is then pulled to withdraw the fastening connecting portion 122 into the body 11, and the elastic element 3 at this point in time is in a compressed state, such that the fastening connecting portion 122 is removed from the second object 20 to separate the first object 10 from the second object 20. Then, the head portion 121 is released to release the elastic element 3, such that the fastening connecting portion 122 is automatically reset in conjunction for the next round of use. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, the locating member 2 includes a sliding seat 21, a pressing portion 22 and at least one limiting portion 23. The pressing portion 22 is provided at one end of the sliding seat 21, the limiting portion 23 is provided on an inner side of the sliding seat 21, and the body 11 is movably provided in the sliding seat 21. In the present invention, the limiting portion 23 is two in quantity, and the two limiting portions 23 are located on two inner sides of the sliding seat 21, respectively.

To put to use, the sliding seat 21 may be moved in a direction toward the fastener 12 to press the pressing portion 22 against the head portion 121 of the fastener 12. Meanwhile, the limiting portions 23 are fitted into outer sides of the body 11 to form limitation by the limiting portions 23 and the outer sides of the body 11, thereby locating the fastening connecting portion 122 at the located position and fasteningly connecting the fastening connecting portion 122 to the second object 20 in a stable manner, so as to stably couple the first object 10 with the second object 20. To separate the first object 10 from the second object 20, the sliding seat 21 is moved in a direction away from the fastener 12 to disengage the limiting portions 23 from the body 11. Meanwhile, the pressing portion 22 leaves the head portion 121, thereby locating the fastening connecting portion 122 at the locating-released position and removing the fastening connecting portion 122 from the second object 20, so as to separate the first object 10 from the second object 20. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, the pressing portion 22 includes a fitting connecting portion 24 on a bottom surface thereof. When the pressing portion 22 presses against the head portion 121 of the fastener 12, the fitting connecting portion 24 may be fitted into the head portion 121 at one end of the fastener 12, so as to stably locate the fastening connecting portion 122 at the located position by pressing of the pressing portion 22.

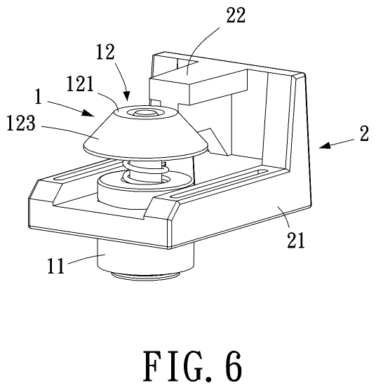

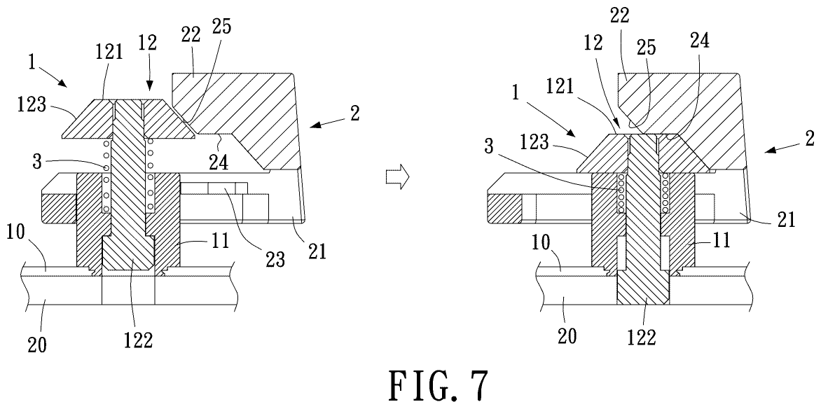

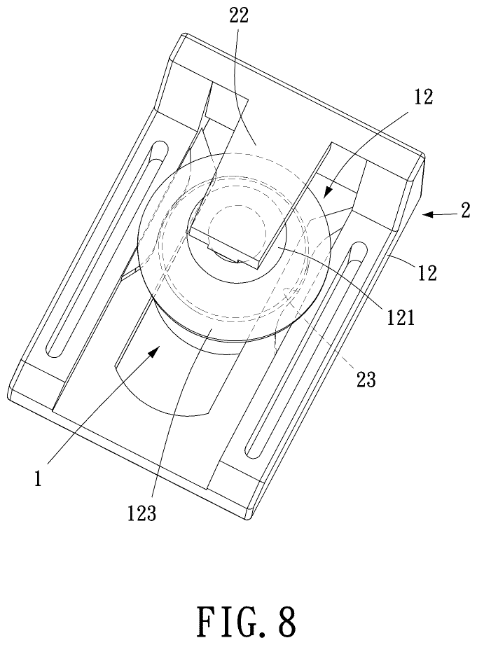

Referring to FIG. 6 to FIG. 8, as shown in the drawings, in a preferred embodiment of the present invention, an elastic element 3 is further included. The elastic element 3 has one end thereof pressing against the body 11, and the other end thereof pressing against the head portion 121, such that the fastening connecting portion 122 is normally located in the body 11.

To put to use, the sliding seat 21 may be moved in a direction toward the fastener 12 to press the pressing portion 22 against the head portion 121 of the fastener 12, and is at the same time fitted into the outer sides of the body 11 by the limiting portions 23 to form limitation by the limiting portions 23 and the outer sides of the body 11, so as to enable the fastening connecting portion 122 extend out of the body 11 and be fasteningly connected to the second object 20 in a stable manner and located at the located position. At this point in time, the elastic element 3 is in a compressed state, thus stably coupling the first object 10 with the second object 20.

To separate the first object 10 from the second object 20, the sliding seat 21 is moved in a direction away from the fastener 12 to disengage the limiting portions 23 from the body 11, and at the same time to have the pressing portion 22 leave the head portion 121. At this point in time, the elastic element 3 is released, such that the fastening connecting portion 122 is pushed back into the body 11, thereby locating the fastening connecting portion 122 at the locating-released position and removing the fastening connecting portion 122 from the second object 20, so as to separate the first object 10 from the second object 20. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, the head portion 121 includes a guiding surface 123 pressing against the pressing portion 22 on the outer periphery thereof, and the pressing portion 22 includes on a bottom surface thereof a connected guiding portion 25 and a fitting connecting portion 24 that are connected. The connected guiding portion 25 may press against the guiding surface 123 on the outer periphery of the head portion 121, and be fitted into the head portion 121 at one end of the fastener 12 by the fitting connecting portion 24, so as to stably locate the fastening connecting portion 122 at the located position by pressing of the pressing portion 22.

In a preferred embodiment of the present invention, the guiding surface 123 and the connected guiding portion 25 may be inclined surfaces, arc surfaces, curved surfaces, stepped surfaces, planar surfaces, protrusions, recesses, notches, grooves, openings, slots or holes. Thus, the guiding surface 123 and the connected guiding portion 25 may be in different structural forms selected according to actual requirements.

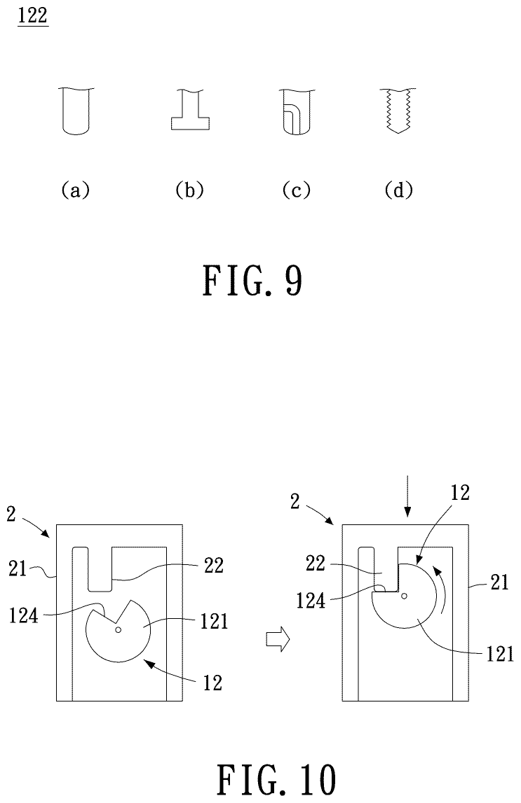

Referring to FIG. 9, as shown in the drawing, in a preferred embodiment of the present invention, the fastening connecting portion 122 is a column (as part a in FIG. 9), a fastener, an outer fastener (as part b in FIG. 9), an inner fastener (as part c in FIG. 9), or a thread body (as part d in FIG. 9). Thus, the fastening connecting portion 122 may be in different structural forms selected according to actual requirements.

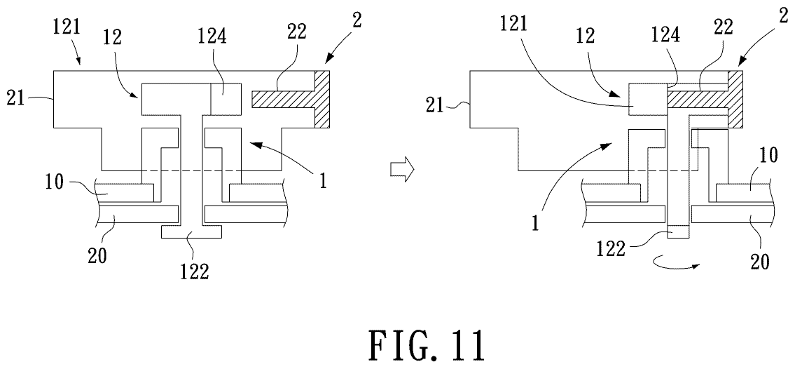

Referring to FIG. 10 and FIG. 11, as shown in the drawings, in a preferred embodiment of the present invention, the locating member 2 includes a pressing portion 22, and the head portion 121 includes a corresponding pressing portion 124 corresponding in position to the pressing portion 22. Thus, the sliding seat 21 may be moved to press the pressing portion 22 against the corresponding pressing portion 124 of the fastener 12, so as to enable the locating member 2 to push and rotate the head portion 121 to further rotate the fastener 12. Thus, the locating member 2 may be moved to locate the fastener 12 at the located position or at the locating-released position, so as to complete coupling and separation of the first object 10 and the second object 20, achieving the objective of repeated quick coupling and separation.

In a preferred embodiment of the present invention, the pressing portion 22 or the corresponding pressing portion 124 is an inclined surface, an arc surface, a curved surface, a stepped surface, a planar surface, a protrusion, a recess, a notch, a groove, an opening, a slot or a hole, so as to enable the present invention to better meet actual application requirements.

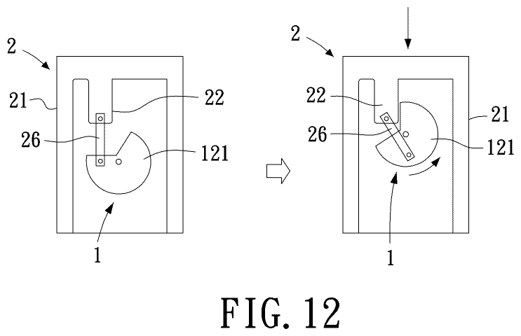

Referring to FIG. 12, as shown in the drawing, in a preferred embodiment of the present invention, a connected connecting portion 26 is provided between the head portion 121 of the fixture 1 and the pressing portion 22 of the locating member 2. The connecting portion 26 is configured to drive the fastening connecting portion 122 and locate the fastening connecting portion 122 at the located position or at the locating-released position, so as to enable the present invention to better meet actual application requirements.

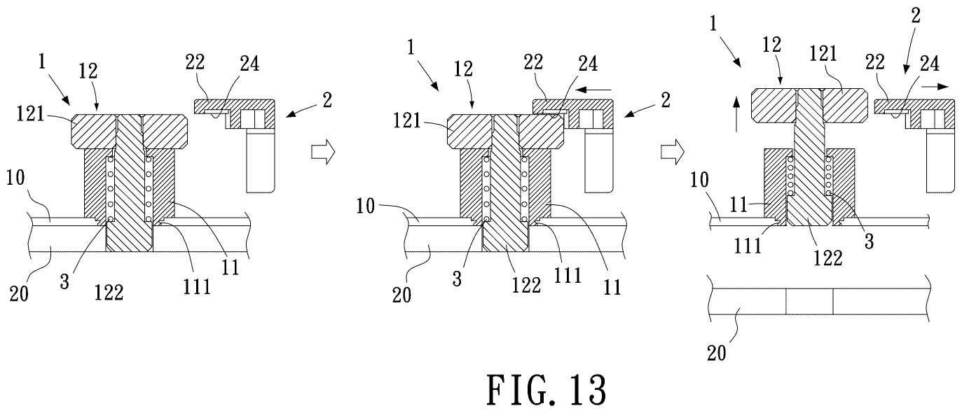

Referring to FIG. 13, as shown in the drawing, in a preferred embodiment of the present invention, a fixture 1 and a locating member 2 are included. The fixture 1 includes a body 11 and a fastener 12, wherein the fastener 12 is movably provided at the body 11. The body 11 is configured to assemble with a first object 10, and the fastener 12 is configured to fasteningly connect to a second object 20 or be removed from the second object 20. The locating member 2 may press against or drive the fastener 12 to locate the fastener 12 at the located position, or the locating member 2 may move away or drive the fastener 12 to locate the fastener 12 at the locating-released position.

To put to use, the head portion 121 may be pulled to first withdraw the fastening connecting portion 122 into the body 11, and the elastic element 3 at this point in time is in a compressed state. Once having corresponded to the second object 20, the head portion 121 is then released to release the elastic element 3 such that the fastening connecting portion 122 is fasteningly connected to the second object 20 automatically. Moreover, the locating member 2 is moved in a direction toward the fastener 12 to press the pressing portion 22 of the locating member 2 against the head portion 121 of the fastener 12 and the fitting connecting portion 24 is fitted into the head portion 121, thereby locating the fastening connecting portion 122 at the located position and fasteningly connecting the fastening connecting portion 122 to the second object 20 in a stable manner, so as to stably couple the first object 10 with the second object 20. To separate the first object 10 from the second object 20, the locating member 2 is moved in a direction away from the fastener 12 to have the bottom of the locating member 2 depart from the head portion 121, thereby locating the fastening connecting portion 122 at the locating-released position. The head portion 121 is then pulled so as to withdraw the fastening connecting portion 122 into the body 11, and the elastic element 3 at this point in time is in a compressed state, such that the fastening connecting portion 122 is removed from the second object 20 to separate the first object 10 from the second object 20. Then, the head portion 121 is released to release the elastic element 3, such that the fastening connecting portion 122 is automatically reset in conjunction for the next round of use. Thus, the locating member 2 may be moved to locate the fastener 12 at the located position or at the locating-released position, so as to complete coupling and separation of the first object 10 and the second object 20, achieving the objective of repeated quick coupling and separation.

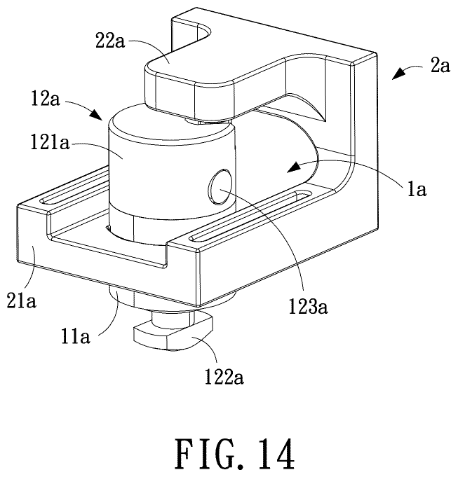

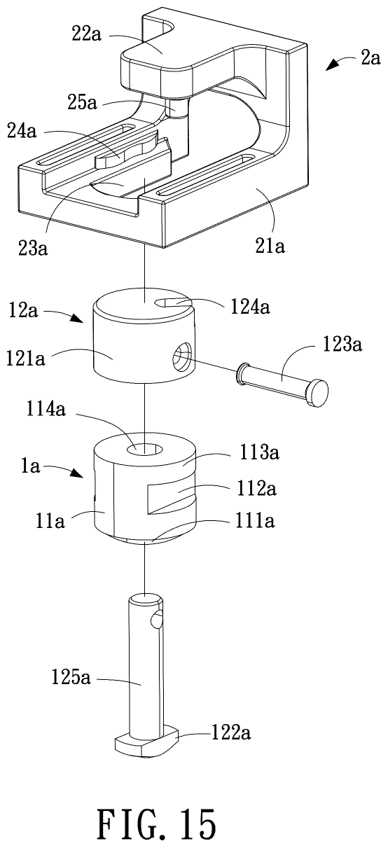

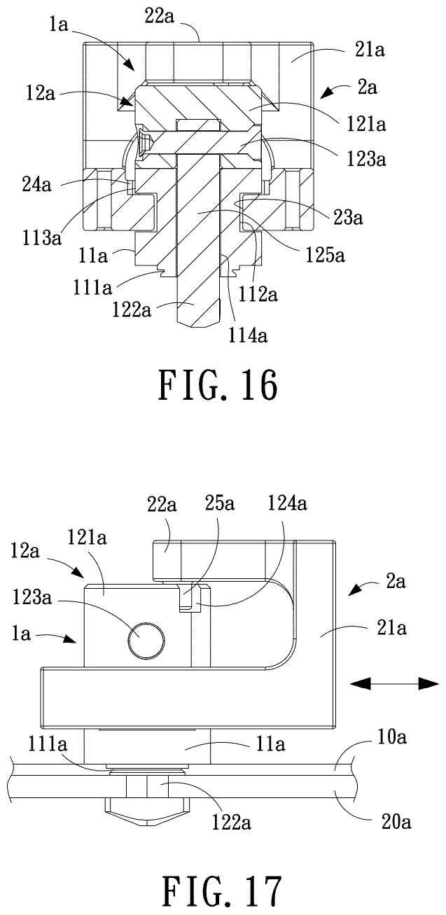

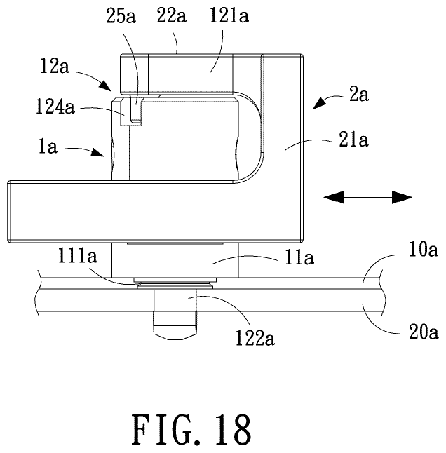

Referring to FIG. 14 to FIG. 18, as shown in the drawings, the present invention provides a locating structure including a fixture 1a and a driving member 2a.

The fixture 1a includes a body 11a and a fastener 12a, wherein the fastener 12a is movably provided at the body 11a. The body 11a is configured to assemble with a first object 10a, and the fastener 12a is configured to fasteningly connect to a second object 20a or be removed from the second object 20a.

The driving member 2a is movably assembled with the body 11a. The driving member 2a may drive the fastener 12a to locate the fastener 12a at a locked position, or the driving member 2a may drive the fastener 12a to locate the fastener 12a at an unlocked position.

To put the present invention to use, the fastener 12a may be fasteningly connected to the second object 20a, and the driving member 2a is then moved toward one side such that the bottom of the driving member 2a drives an end surface of the fastener 12a, thereby locating the fastener 12a at the locked position and fasteningly connecting the fastener 12a to the second object 20a in a stable manner, so as to stably couple the first object 10a with the second object 20a.

To separate the first object 10a from the second object 20a, the driving member 2a is moved toward the other side, such that the bottom of the driving member 2a drives the end surface of the fastener 12a, thereby locating the fastener 12a at the unlocked position and removing the fastener 12a from the second object 20a, so as to separate the first object 10a from the second object 20a. Thus, the driving member 2a may be moved to locate the fastener 12a at the locked position or at the unlocked position, so as to complete coupling and separation of the first object 10a and the second object 20a, achieving the objective of repeated quick coupling and separation.

In a preferred embodiment of the present invention, the body 11a includes a joining portion 111a, and the joining portion 111a is configured to assemble with the first object 10a. Thus, the body 11a may be stably coupled to the first object 10a by using the joining portion 111a, so as to facilitate subsequent operations of the fastener 12a and the driving member 2a.

In a preferred embodiment of the present invention, the fastener 12a includes a head portion 121a at one end thereof and a fastening connecting portion 122a at the other end thereof. The fastening connecting portion 122a may be fasteningly connected to the second object 20a. The driving member 2a may drive the head portion 121a to locate the fastening connecting portion 122a at a locked position or at an unlocked position. Thus, the fastening connecting portion 122a of the fastener 12a may be fasteningly connected to the second object 20a, and the driving member 2a is then moved toward one side to have the bottom of the driving member 2a drive the head portion 121a at one end of the fastener 12a, thereby locating the fastening connecting portion 122a at the locked position and fasteningly connecting the fastening connecting portion 122a to the second object 20a in a stable manner, so as to stably couple the first object 10a with the second object 20a.

To separate the first object 10a from the second object 20a, the driving member 2a is moved toward the other side to have the bottom of the driving member 2a depart from the head portion 121a, thereby locating the fastening connecting portion 122a at the unlocked position and removing the fastening connecting portion 122a from the second object 20a, so as to separate the first object 10a from the second object 20a. Thus, the driving member 2a may be moved to locate the fastener 12a at the locked position or at the unlocked position, so as to complete coupling and separation of the first object 10a and the second object 20a, achieving the objective of repeated quick coupling and separation.

In a preferred embodiment of the present invention, the head portion 121a and the fastening connecting portion 122a are assembled by an assembly portion 123. Thus, when the driving member 2a drives the head portion 121a, the fastening connecting portion 122a may be simultaneously driven to be located at the locked position or the unlocked position by the provided assembly portion 123, so as to complete coupling and separation of the first object 10a and the second object 20a, achieving the objective of repeated quick coupling and separation.

In a preferred embodiment of the present invention, the body 11a includes a guiding portion 112a on each of two sides of the outer periphery thereof and a blocking portion 113a on the outer periphery of the top end thereof, and the head portion 121a includes a butting connecting portion 124a on an end surface thereof. The driving member 2a includes a sliding seat 21a, an impelling portion 22a, at least one sliding portion 23a and at least one locating portion 24a. The impelling portion 22a is provided at one end of the sliding seat 21a, the sliding portion 23a is provided on two inner edges of the sliding seat 21a, the locating portion 24a is provided on two inner edges of the sliding seat 21a, and the locating portion 24a may be detachably joined to the blocking portion 113a. In the present invention, the sliding portion 23a is located above the locating portion 24a, and the impelling portion 22a includes a fitting connecting portion 25a on the bottom surface thereof. The guiding portion 112a of the body 11a is movably provided at the sliding portion 23a of the sliding seat 21a, and the fitting connecting portion 25a of the impelling portion 22a is connected to the butting connecting portion 124a.

To put to use, the sliding seat 21a may be moved toward one side to have the sliding portion 23a perform guiding by the guiding portion 112a of the body 11a, and to simultaneously move the impelling portion 22a, and the fitting connecting portion 25a drives in collaboration with the butting connecting portion 124a to rotate the head portion 121a. Meanwhile, limitation is formed by the locating portion 24a and the blocking portion 113a, thereby locating the fastening connecting portion 122a at the locked position and fasteningly connecting the fastening connecting portion 122a to the second object 20a in a stable manner, so as to stably couple the first object 10a with the second object 20a.

To separate the first object 10a from the second object 20a, the sliding seat 21a is moved toward the other side to have the sliding portion 23a perform guiding by the guiding portion 112a of the body 11a, and to simultaneously move the impelling portion 22a, and the fitting connecting portion 25a drives in collaboration with the butting connecting portion 124a to rotate the head portion 121a in reverse. Meanwhile, the locating portion 24a is moved away from the blocking portion 113a, thereby locating the fastening connecting portion 122a at the unlocked position and removing the fastening connecting portion 122a from the second object 20a, so as to separate the first object 10a from the second object 20a. Thus, the driving member 2a may be moved to locate the fastener 12a at the locked position or at the unlocked position, so as to complete coupling and separation of the first object 10a and the second object 20a, achieving the objective of repeated quick coupling and separation.

While the present disclosure has been described by means of specific embodiments, numerous modifications and variations could be made thereto by those skilled in the art without departing from the scope and spirit of the present disclosure set forth in the claims.

What is claimed is:

1. A locating structure, comprising:
a fixture, comprising a body and a fastener, the fastener being movably provided at the body, the body configured to assemble with a first object, the fastener configured to fasteningly connect to a second object or be removed from the second object; and
a locating member, movably assembled with the body, the locating member configured to press against or drive the fastener to locate the fastener at a located position, or the locating member configured to move away or drive the fastener to locate the fastener at a locating-released position; or being provided with a driving member movably assembled with the body, the driving member configured to drive the fastener to locate the fastener at a locked position, or the driving member configured to drive the fastener to locate the fastener at an unlocked position;
wherein the body includes a guiding portion on an outer periphery thereof, the locating member includes a sliding portion on an inner side thereof, and the guiding portion is movably provided at the sliding portion; or the body includes a guiding portion on an outer periphery thereof, the driving member includes a sliding portion on an inner side thereof, and the guiding portion is movably provided at the sliding portion.

2. A locating structure, comprising:
a fixture, comprising a body and a fastener, the fastener being movably provided at the body, the body configured to assemble with a first object, the fastener configured to fasteningly connect to a second object or be removed from the second object; and
a locating member, the locating member configured to press against or drive the fastener to locate the fastener at a located position, or the locating member configured to move away or drive the fastener to locate the fastener at a locating-released position; or being provided with a driving member movably assembled with the body, the driving member configured to drive the fastener to locate the fastener at a locked position, or the driving member configured to drive the fastener to locate the fastener at an unlocked position;
wherein the body includes a guiding portion on an outer periphery thereof, the locating member includes a sliding portion on an inner side thereof, and the guiding portion is movably provided at the sliding portion; or the body includes a guiding portion on an outer periphery thereof, the driving member includes a sliding portion on an inner side thereof, and the guiding portion is movably provided at the sliding portion.

3. The locating structure according to claim 1, wherein the fastener comprises a head portion at one end thereof and a fastening connecting portion at the other end thereof, the fastening connecting portion is configured to fasteningly connect to the second object, and the locating member is configured to press against, move away, push, rotate or drive the head portion to locate the fastening connecting portion at the located position or at the locating-released position.

4. The locating structure according to claim 2, wherein the fastener comprises a head portion at one end thereof and a fastening connecting portion at the other end thereof, the fastening connecting portion is configured to fasteningly connect to the second object, and the locating member is configured to press against, move away, push, rotate or drive the head portion to locate the fastening connecting portion at the located position or at the locating-released position.

5. The locating structure according to claim 3, further comprising an elastic element, the elastic element having one end thereof pressing against the body and the other end thereof pressing against the fastening connecting portion.

6. The locating structure according to claim 4, further comprising an elastic element, the elastic element having one end thereof pressing against the body and the other end thereof pressing against the fastening connecting portion.

7. The locating structure according to claim 3, further comprising an elastic element, the elastic element having one end thereof pressing against the body and the other end thereof pressing against the head portion.

8. The locating structure according to claim 4, further comprising an elastic element, the elastic element having one end thereof pressing against the body and the other end thereof pressing against the head portion.

9. The locating structure according to claim 1, further comprising an elastic element, the elastic element having one end thereof pressing against the body and the other end thereof pressing against the fastener.

10. The locating structure according to claim 2, further comprising an elastic element, the elastic element having one end thereof pressing against the body and the other end thereof pressing against the fastener.

11. The locating structure according to claim 3, wherein the head portion comprises a guiding surface pressing against the locating member on an outer periphery thereof.

12. The locating structure according to claim 4, wherein the head portion comprises a guiding surface pressing against the locating member on an outer periphery thereof.

13. The locating structure according to claim 1, wherein the locating member comprises a sliding seat or a pressing portion, and the pressing portion is provided at one end of the sliding seat.

14. The locating structure according to claim 2, wherein the locating member comprises a sliding seat or a pressing portion, and the pressing portion is provided at one end of the sliding seat.

15. The locating structure according to claim 13, wherein the locating member comprises a limiting portion; the sliding seat is moved to press the pressing portion against the fastener and to form limitation by the limiting portion and an outer side of the body so as to locate the fastener at the located position, or the pressing portion is capable of moving away the fastener to disengage the limiting portion from the body so as to locate the fastener at the locating-released position; or, the pressing portion comprises a fitting connecting portion, and the fitting connecting portion is capable of fitting into one end of the fastener; or, the pressing portion comprises a connected guiding portion, and the connected guiding portion is configured to press against an outer periphery of the head portion.

16. The locating structure according to claim 14, wherein the locating member comprises a limiting portion; the sliding seat is moved to press the pressing portion against the fastener and to form limitation by the limiting portion and an outer side of the body so as to locate the fastener at the located position, or the pressing portion is capable of moving away the fastener to disengage the limiting portion from the body so as to locate the fastener at the locating-released position; or, the pressing portion comprises a fitting connecting portion, and the fitting connecting portion is capable of fitting into one end of the fastener; or, the pressing portion comprises a connected guiding portion, and the connected guiding portion is configured to press against an outer periphery of the head portion.

17. The locating structure according to claim 1, wherein the locating member comprises a sliding seat, a pressing portion or at least one limiting portion; the pressing portion is provided at one end of the sliding seat, the limiting portion is provided on an inner side of the sliding seat, and the body is movably provided in the sliding seat.

18. The locating structure according to claim 2, wherein the locating member comprises a sliding seat, a pressing portion or at least one limiting portion; the pressing portion is provided at one end of the sliding seat, the limiting portion is provided on an inner side of the sliding seat, and the body is movably provided in the sliding seat.

19. The locating structure according to claim 13, wherein the sliding seat is moved to press the pressing portion against the fastener so as to locate the fastener at the locked position, or the pressing portion moves away the fastener to disengage the limiting portion from the body so as to locate the fastener at the unlocked position; or, the sliding seat is moved to press the pressing portion against the fastener so as to rotate the fastener.

20. The locating structure according to claim 14, wherein the sliding seat is moved to press the pressing portion against the fastener so as to locate the fastener at the locked position, or the pressing portion moves away the fastener to disengage the limiting portion from the body so as to locate the fastener at the unlocked position; or, the sliding seat is moved to press the pressing portion against the fastener so as to rotate the fastener.

21. The locating structure according to claim 1, wherein the fastener comprises a head portion at one end thereof and a fastening connecting portion at the other end thereof, and the locating member is configured to press against, move away, push, rotate or drive the head portion; or, the locating member comprises a pressing portion, and the head portion comprises a corresponding pressing portion corresponding in position to the pressing portion.

22. The locating structure according to claim 2, wherein the fastener comprises a head portion at one end thereof and a fastening connecting portion at the other end thereof, and the locating member is configured to press against, move away, push, rotate or drive the head portion; or, the locating member comprises a pressing portion, and the head portion comprises a corresponding pressing portion corresponding in position to the pressing portion.

23. The locating structure according to claim 3, wherein the locating member comprises a pressing portion, and the head portion comprises a corresponding pressing portion corresponding in position to the pressing portion.

24. The locating structure according to claim 4, wherein the locating member comprises a pressing portion, and the head portion comprises a corresponding pressing portion corresponding in position to the pressing portion.

25. The locating structure according to claim 1, wherein the fixture and the locating member comprise a connected connecting portion, and the connecting portion is configured to drive the fastener so as to locate the fastener at the located position or at the locating-released position.

26. The locating structure according to claim 2, wherein the fixture and the locating member comprise a connected connecting portion, and the connecting portion is configured to drive the fastener so as to locate the fastener at the located position or at the locating-released position.

27. The locating structure according to claim 3, wherein the head portion and the locating member comprise a connected connecting portion, and the connecting portion is configured to drive the fastening connecting portion so as to locate the fastening connecting portion at the located position or at the locating-released position.

28. The locating structure according to claim 4, wherein the head portion and the locating member comprise a connected connecting portion, and the connecting portion is configured to drive the fastening connecting portion so as to locate the fastening connecting portion at the located position or at the locating-released position.

29. The locating structure according to claim 13, wherein the head portion and the pressing portion comprise a connected connecting portion, and the connecting portion is configured to drive the fastening connecting portion so as to locate the fastening connecting portion at the located position or at the locating-released position.

30. The locating structure according to claim 14, wherein the head portion and the pressing portion comprise a connected connecting portion, and the connecting portion is configured to drive the fastening connecting portion so as to locate the fastening connecting portion at the located position or at the locating-released position.

31. The locating structure according to claim 13, wherein the pressing portion comprises a connected guiding portion or a fitting connecting portion, and the connected guiding portion is configured to press against an outer periphery of the head portion and then to be fitted into one end of the fastener by the fitting connecting portion.

32. The locating structure according to claim 14, wherein the pressing portion comprises a connected guiding portion or a fitting connecting portion, and the connected guiding portion is configured to press against an outer periphery of the head portion and then to be fitted into one end of the fastener by the fitting connecting portion.

33. The locating structure according to claim 1, wherein the body comprises a blocking portion on an outer periphery of a top end thereof, and the blocking portion is configured to perform blocking and limiting on an inner side of the driving member.

34. The locating structure according to claim 2, wherein the body comprises a blocking portion on an outer periphery of a top end thereof, and the blocking portion is configured to perform blocking and limiting on an inner side of the driving member.

35. The locating structure according to claim 1, wherein the driving member comprises a sliding seat, an impelling portion, at least one sliding portion and at least one locating portion; the impelling portion is provided at one end of the sliding seat, the sliding portion is provided on an inner side of the sliding seat, and the locating portion is provided on an inner side of the sliding seat.

36. The locating structure according to claim 2, wherein the driving member comprises a sliding seat, an impelling portion, at least one sliding portion and at least one locating portion; the impelling portion is provided at one end of the sliding seat, the sliding portion is provided on an inner side of the sliding seat, and the locating portion is provided on an inner side of the sliding seat.

37. The locating structure according to claim 35, wherein the body is movably provided in the sliding seat, the impelling portion is connected to an end surface of the fastener and is accordingly capable of moving the sliding seat to enable the sliding portion to perform guiding on an outer periphery of the body, and the impelling portion drives the fastener and forms limitation by the liming portion and an outer side of the body so as to locate the fastener at the locked position, or the impelling portion moves away the fastener to disengage the locating portion from the body so as to locate the fastener at the unlocked position.

38. The locating structure according to claim 36, wherein the body is movably provided in the sliding seat, the impelling portion is connected to an end surface of the fastener and is accordingly capable of moving the sliding seat to enable the sliding portion to perform guiding on an outer periphery of the body, and the impelling portion drives the fastener and forms limitation by the liming portion and an outer side of the body so as to locate the fastener at the locked position, or the impelling portion moves away the fastener to disengage the locating portion from the body so as to locate the fastener at the unlocked position.

39. The locating structure according to claim 35, wherein the impelling portion comprises a fitting connecting portion on a bottom surface thereof, and the fitting connecting portion is capable of fitting into an end surface of the fastener.

40. The locating structure according to claim 36, wherein the impelling portion comprises a fitting connecting portion on a bottom surface thereof, and the fitting connecting portion is capable of fitting into an end surface of the fastener.
